(19) United States
(12) Patent Application Publication
(10) Pub. No.: US 2026/0064067 A1
(43) Pub. Date: Mar. 5, 2026

(54) IMAGE FORMATION APPARATUS

(71) Applicant: Oki Electric Industry Co., Ltd., Tokyo (JP)

(72) Inventor: Masashi FUJII, Tokyo (JP)

(73) Assignee: Oki Electric Industry Co., Ltd., Tokyo (JP)

(21) Appl. No.: 19/228,643

(22) Filed: Jun. 4, 2025

(30) Foreign Application Priority Data
Sep. 4, 2024 (JP) 2024-152141

(51) Int. Cl. G03G 15/00; G03G 15/01

(52) U.S. Cl. CPC G03G 15/6567; G03G 15/0194; G03G 15/657

(57) ABSTRACT

An image formation apparatus according to an embodiment includes: a conveyance belt configured to convey a medium supplied from a medium feeder toward a fixation device along a conveyance direction; an image transfer part configured to transfer an image formed on an image carrier at a transfer position to the medium being conveyed by the conveyance belt; and a flexible guide member that is provided upstream in the conveyance direction of the transfer position, and is arranged to approach the conveyance belt as the guide member extends downstream in the conveyance direction. The shortest distance from a guide member end, which is one of end portions of the guide member located closer to the conveyance belt than the other to the conveyance belt, to the conveyance belt is greater than a maximum medium thickness specified in the apparatus specifications of the image formation apparatus.

### CROSS REFERENCE TO RELATED APPLICATIONS

This application claims priority based on 35 USC 119 from prior Japanese Patent Application No. 2024-152141 filed on September 4, 2024, entitled “IMAGE FORMATION APPARATUS”, the entire contents of which are incorporated herein by reference.

### BACKGROUND

The disclosure may relate to an image formation apparatus and may be suitably applicable, for example, to an electrophotographic printer.

In a related art, there is widely known an image formation apparatus that prints an image by forming a toner image with an image formation unit, transferring the toner image to paper (also referred to as a medium) conveyed by a conveyance unit, and fixing the toner image to the paper using a fixation unit that applies heat and pressure to the paper.

The conveyance unit includes, for example, two belt rollers arranged at two positions along a conveyance path of the paper, and a conveyance belt stretched between and around the two belt rollers. The conveyance unit of such a configuration can drive the conveyance belt with sandwiching the paper between the conveyance belt and a predetermined roller(s) or the like, thereby conveying the paper along the conveyance path (e.g., see Patent Document 1).

Patent Document 1: Japanese Patent Application Publication No. 2024-001697 (see FIG. 2)

The image formation unit of the image formation apparatus described above includes an image carrier such as a photosensitive drum formed in a cylindrical shape, and is configured to form an electrostatic latent image on the image carrier by exposure processing, and form a toner image by attaching a thin film toner to the electrostatic latent image. The image formation apparatus described in Patent Document 1 is a so-called direct transfer system, which includes an image transfer point formed by sandwiching a transfer belt, which is stretched along a conveyance path, between a transfer roller and an image carrier (photosensitive drum) of the image formation unit. In the image formation apparatus, a transfer process is performed in which a toner image is transferred at the transfer point from the image carrier of the image formation unit to the medium such as a paper conveyed by the conveyance belt of the conveyance unit.

However, in the image formation apparatus, warpage may occur in the medium, for example, after the printing process on the first side of the medium is completed during two-sided printing. In particular, if the vicinity of the leading end portion of the medium conveyed by the conveyance unit is warped away from the conveyance belt, the position of the medium relative to the conveyance belt becomes unstable. This may result in misalignment during toner image transfer or poor image transfer at the leading end portion of the medium. In such cases, the image formation apparatus may experience a problem in which the quality of the image printed on the medium may be degraded.

### SUMMARY

An object of an embodiment of the disclosure may be to provide an image formation apparatus capable of enhancing the quality of an image printed on a medium.

An aspect of the disclosure may be an image formation apparatus that may include: a medium feeder configured to supply a medium; a conveyance belt configured to convey the medium supplied from the medium feeder toward a fixation device along a conveyance direction; an image transfer part configured to transfer an image formed on an image carrier at a transfer position to the medium being conveyed by the conveyance belt; and a flexible guide member that is provided upstream in the conveyance direction of the transfer position in the image transfer part, and is arranged to approach the conveyance belt as the guide member extends downstream in the conveyance direction. A shortest distance from a guide member end, which is an end portion of the guide member located on the side close to the conveyance belt, to the conveyance belt is greater than a maximum medium thickness specified in the apparatus specifications of the image formation apparatus.

Another aspect of the disclosure may be an image formation apparatus that may include: a medium feeder configured to supply a medium, a conveyance belt configured to convey the medium supplied from the medium feeder toward a fixation device along a conveyance direction; an image transfer part configured to transfer an image formed on an image carrier at a transfer position to the medium being conveyed by the conveyance belt; and a flexible guide member that is provided upstream of the conveyance direction from the transfer position in the image transfer part, and is arranged to approach the conveyance belt as the guide member extends downstream in the conveyance direction. A first distance, defined as a shortest distance from a guide member end, which is an end portion of the guide member located on the side close to the conveyance belt, to the conveyance belt is smaller than a second distance, defined as a shortest distance from the guide member end to the image carrier.

According to at least one of the aspects described above, even if the leading end portion of the medium being conveyed by the conveyance belt is shifted from the belt, the leading end portion is brought into contact with and slides along the guide member, and is guided to the end portion of the guide member, thereby being brought closer to the conveyance belt. Accordingly, the medium can be stably conveyed along the conveyance belt, and the leading end portion of the medium can also be prevented from coming into contact with the image carrier and scraping off the image from the image carrier.

Therefore, it may be possible to realize an image formation apparatus capable of enhancing the quality of an image printed on a medium.

### BRIEF DESCRIPTION OF DRAWINGS

FIG. 1 is a diagram illustrating a schematic side view of an overall configuration of an image formation apparatus;

FIG. 2 is a diagram illustrating a schematic side view of a configuration of an image formation unit;

FIGS. 3A and 3B are diagrams illustrating schematic perspective views of a configuration of the image formation unit;

FIG. 4 is a diagram illustrating a schematic perspective view of a configuration of an image drum unit;

FIG. 5 is a diagram illustrating a schematic enlarged view of a configuration of the image drum unit;

FIG. 6 is a diagram illustrating a schematic enlarged view of a configuration of the image drum unit;

FIG. 7 illustrates schematic diagrams (A) to (F) illustrating a procedure for measuring a lower end-to-belt distance;

FIG. 8 is a schematic diagram illustrating a state (1) of paper conveyance;

FIG. 9 is a schematic diagram illustrating a state (2) of paper conveyance;

FIG. 10 is a schematic diagram illustrating a state (3) of paper conveyance; and

FIG. 11 is a schematic diagram illustrating a state (4) of paper conveyance.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

### 1. Configuration of Image formation apparatus

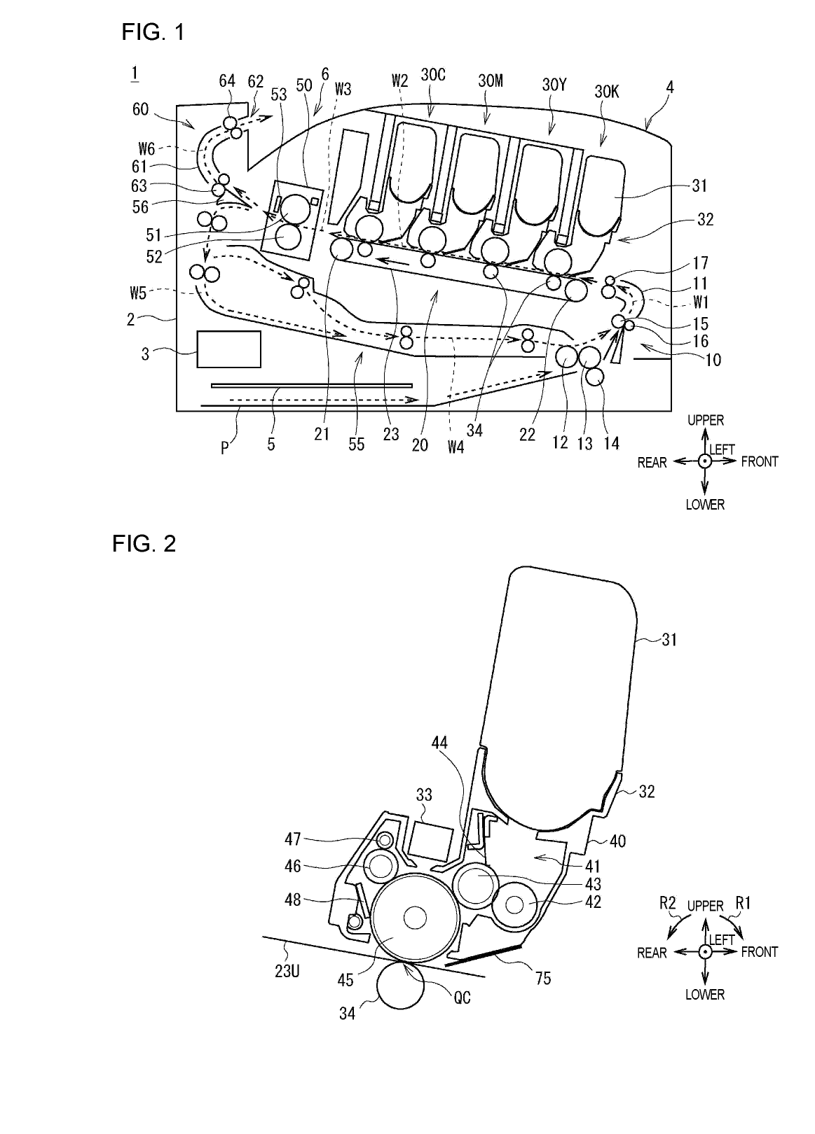

As illustrated in FIG. 1, an image formation apparatus 1 according to an embodiment is an electrophotographic printer and is configured to form (i.e., print) color images on sheets of paper P, serving as media, such as plain paper or coated paper. Note that the image formation apparatus 1 illustrated in FIG. 1 is a single function printer (SFP) having a printer function, without having an image scanner function to read a document, a communication function using a telephone line, or the like.

The image formation apparatus 1 includes various components arranged inside a housing 2 (an apparatus housing), which is substantially box-shaped. In the following description, the rightmost side in FIG. 1 is the front of the image formation apparatus 1, and the vertical, horizontal, and front-rear directions are defined as seen facing the front.

The image formation apparatus 1 is configured to control the overall operation of the image formation apparatus by a controller 3. The controller 3 is connected to a host device or an external device such as a computer device (not illustrated). The controller 3 executes an image forming process (also referred to as a printing process) that forms a print image on the surface of the paper P upon receiving a print instruction and/or printing data from the host device.

An operation panel 4, for displaying various information and receiving an operation input, is provided on a front portion of the upper surface of the housing 2. This operation panel 4 includes, for example, a touch panel combining a display panel such as a liquid crystal panel with a touch sensor, and may also include components such as LEDs (Light Emitting Diodes). The operation panel 4 is configured to display various information based on the control of the controller 3 and receive the operation input from the user.

A tray 5, in which the paper P is to be stored, is provided at a lowest end portion of the housing 2. This tray 5 is configured to accommodate therein the paper P up to A3 size, with the short side aligned along the left-right (lateral) direction. A paper feeder 10 or a medium feeder is provided on an upper front side of the tray 5. A paper feeder 10 forms a feeding path W1, which is a path for conveying the paper P, by conveyance guides 11 facing each other at a predetermined distance.

The paper feeder 10 includes a pick-up roller 12, a feeding roller 13, a separation roller 14, a resist roller 15, a pressure roller 16, and a pair of conveyance rollers 17 along the feeding path W1. Each roller is formed in a cylindrical shape along the center axis in the left-right direction and is rotatably supported. A driving force is transmitted from a feed motor (not illustrated) to part of the rollers. The conveyance roller pair 17 includes conveyance rollers which are opposed each other across the feeding path W1.

Under the control of the controller 3, the paper feeder 10 appropriately rotates the rollers to separate stacked sheets of the paper P stored in the tray 5 one by one, thereby picking up and conveying the paper P. Specifically, a pick-up roller 12 pulls out the paper P from the tray 5. The feed roller 13 advances the paper P, which has been drawn from the tray 5 by the pick-up roller 12, along the feeding path W1. When multiple sheets of paper P are drawn from the tray 5, the separation roller 14 separates the top sheet from the remaining sheet(s). The resist roller 15 and the pressure roller 16 correct the orientation (i.e., the direction of each edge with respect to the traveling direction) of the paper P when it is skewed relative to the feeding path W1, and then convey the paper in the corrected orientation. The conveyance roller pair 17 conveys the paper P along the feeding path W1 and further conveys it obliquely upward and backward.

On the rear and upper side of the conveyance roller pair 17 of the paper feeder 10, a conveying unit 20 (conveying device 20) and four image formation units 30 (image formation devices 30) are disposed with the four image formation units 30 positioned above the conveying unit 20. A transfer path W2 is formed between the conveying unit 20 and the plurality of image formation units 30. The transfer path W2 is connected to the feeding path W1 and extends in a straight line obliquely upward toward the rear.

The conveying unit 20 includes a drive roller 21, an idle roller 22, a conveyance belt 23, and the like. The drive roller 21 and the idle roller 22 are each formed in a cylindrical shape with a center axis thereof extending in the left-right direction, and are rotatably supported.

The drive roller 21 is disposed relatively on the rear side and is configured to be rotated by a driving force supplied from a drive source (not illustrated). The idle roller 22 is located slightly in front of and below the drive roller 21, and is positioned in the vicinity of the conveyance roller pair 17.

The conveyance belt 23 is a flexible endless belt stretched between and around the drive roller 21 and the idle roller 22. The upper part of the conveyance belt 23 (hereinafter referred to as the upper part 23U of conveyance belt or the upper conveyance belt part 23U) is stretched in a straight line connecting the vicinity of the upper end of the drive roller 21 and the vicinity of the upper end of the idle roller 22, and lies linearly along the transfer path W2.

With such a configuration, in the conveying unit 20, when the drive roller 21 is rotated counterclockwise in FIG. 1, the conveyance belt 23 is driven to move, thereby causing the idle roller 22 to rotate accordingly. At this time, the upper part 23U of the conveyance belt travels obliquely upward along the transfer path W2.

The four image formation units 30 (30K, 30Y, 30M, and 30C) are arranged mainly above the conveyance unit 20, aligned along the transfer path W2, that is, in a diagonal direction extending from the front lower side to the rear upper side. The image formation units 30 respectively correspond to black (K), yellow (Y), magenta (M), and cyan (C), but although are different only in color and have the same configuration.

As illustrated in the schematic enlarged view in FIG. 2, each image formation unit 30 includes a toner cartridge 31, an image drum (ID) unit 32, an exposure head 33, a transfer roller 34, and the like. Of these, the toner cartridge 31 and the image drum unit 32 are configured to be attachable to and detachable from the housing 2. Furthermore, the toner cartridge 31 is configured to be attachable to and detachable from the image drum unit 32.

The toner cartridge 31, serving as a developer storage, includes a space for storing the toner (also referred to as a developer) therein. The toner cartridge 31 includes a supply port formed on a lower side surface thereof and is configured to supply the toner from the supply port to the image drum unit 32.

The image drum unit 32 includes a base frame 40 forming an outer shell portion and serving as a support member or a support body, and a toner storage space 41 that is provided in the base frame 40 for storing the toner therein. The image drum unit 32 also includes a supply roller 42, a development roller 43, a development blade 44, a photosensitive drum 45, a charging roller 46, a charging cleaning roller 47, a cleaning member 48, and the like, which are appropriately arranged at positions on the rear and lower side of the toner storage space 41.

In a state where the toner cartridge 31 is attached to the upper side of the base frame 40, the toner storage space 41 receives and stores therein the toner supplied from the toner cartridge 31. The toner storage space 41 is provided with a toner stirring member (not illustrated), which appropriately stirs the stored toner to prevent the toner from agglomerating and smoothly supply the toner to the supply roller 42 and the like.

Each of the supply roller 42, the development roller 43, the photosensitive drum 45, the charging roller 46, and the charging cleaning roller 47 is configured in a cylindrical column shape or a cylindrical tubular shape with a center axis thereof extending in the left-right direction, and is rotatably supported. These rollers, drum and the like are rotated by driving force supplied from a drum motor (not illustrated).

The supply roller 42, serving as a developer supply member, is arranged at a lower portion in the toner storage space 41. The development roller 43 is provided above and behind the supply roller 42 such that the development roller 43 is in contact with both the supply roller 42 and the photosensitive drum 45. The supply roller 42 and the development roller 43 are each formed in a cylindrical shape with the center axis extending in the left-right direction, and are rotatably supported by the base frame 40 about the respective center axes. A supply voltage and a developing voltage, both of which are predetermined high voltages, are applied to the supply roller 42 and the development roller 43, respectively. The development blade 44 is formed in a thin plate shape, and has one end thereof fixed to the base frame 40 and the other end thereof abutted against the circumferential surface of the development roller 43 so as to apply an elastic force on the development roller 43.

The photosensitive drum 45, serving as an image carrier, is formed in a cylindrical shape with a center axis thereof extending in the left-right direction, and is rotatably supported by the base frame 40 about the center axis. The photosensitive drum 45 includes a thin charge generation layer and a thin charge transport layer sequentially formed on the circumferential surface thereof, and thus is able to be charged. The charging roller 46, serving as a charging member, is formed in a cylindrical shape with the center axis thereof extending in the left-right direction, is supported rotatably by the base frame 40 about the center axis thereof such that the charging roller 46 is in contact with the front upper side of the photosensitive drum 45. The charging cleaning roller 47 is arranged above and in contact with the charging roller 46. The charging cleaning roller 47 rotates along with the rotation of the charging roller 46 or rotates at the circumferential speed different from that of the charging roller 46.

The exposure head 33 is also called an exposure part or the like, is formed in a shape of an elongated bar extending in the left-right direction, and is located above the photosensitive drum 45. The exposure head 33 includes a plurality of LED (Light Emitting Diode) elements, serving as light emitting elements, arranged along a main scanning direction (e.g., the left-right direction), and also includes a rod lens array and the like. The exposure head 33, when appropriately emitting light from each LED element under the control of the controller 3, directs the light downward while converging it, thereby focusing it on the upper end portion of the circumferential surface of the photosensitive drum 45. As a result, the circumferential surface of the photosensitive drum 45 is exposed with the lights, thereby forming an electrostatic latent image on the circumferential surface of the photosensitive drum 45.

The cleaning member 48 is provided on the front side of the photosensitive drum 45, and is made of a flexible resin material and has a thin plate shape. A front end portion of the cleaning member 48 is fixed to the base frame 40 and a vicinity of a rear end of the cleaning member 48 is in contact with the circumferential surface of the photosensitive drum 45.

The transfer roller 34 is formed in a cylindrical shape with the center axis extending along the left-right direction. The transfer roller 34 is disposed on the lower side of the conveyance belt 23 and at a position facing the photosensitive drum 45. The transfer roller 34 is biased in a forward and upward direction by a biasing member (not illustrated), i.e., toward the photosensitive drum 45. Accordingly, the transfer roller 34 sandwiches the conveyance belt 23 against the photosensitive drum 45, and when the paper P is being conveyed along the transfer path W2, the transfer roller 34 sandwiches the paper P against the conveyance belt 23.

In the following, the upper part of the conveyance belt 23, which extends along the transfer path W2, is referred to as an upper conveyance belt part 23U, and the direction in which the upper conveyance belt part 23U travels—namely, the rearward and upward diagonal direction—may be referred to as a conveyance direction. In the following, the portion where the conveyance belt 23 is sandwiched (i.e., nipped) by the photosensitive drum 45 and the transfer roller 34 is referred to as a transfer position QC.

In this configuration, when performing printing process, each image formation unit 30 rotates the development roller 43, the charging roller 46, and the transfer roller 34 in the image drum unit 32 in the direction of arrow R2 and rotates the photosensitive drum 45 and the supply roller 42 in the image drum unit 32 in the direction of arrow R, under the control of the controller 3. The image formation unit 30 also supplies predetermined high voltages to the development roller 43, the supply roller 42, the development blade 44, the charging roller 46, and the transfer roller 34, respectively, under the control of the controller 3.

The charged supply roller 42 causes toner in the toner storage space 41 to adhere to the circumferential surface of the supply roller 42, and transfers the adhered toner to the circumferential surface of the development roller 43, as the supply roller 42 rotates. The development blade 44 removes excessive toner from the circumferential surface of the development roller 43 to form a thin toner layer. As the development roller 43 rotates, the thin toner layer on the development roller 43 comes in contact with the circumferential surface of the photosensitive drum 45.

The charging roller 46, in a charged state, is in contacts the photosensitive drum 45 to uniformly charge the circumferential surface of the photosensitive drum 45. At this time, the charging cleaning roller 47 removes toner and external additives of the toner that are adhered to the charging roller 46.

The controller 3 generates image data based on the print job received from the external device (not illustrated), and provides the image data to the exposure head 33 as dot data for each line. The exposure head 33 emits the lights in a light emission pattern based on the provided dot data, and exposes the photosensitive drum 45. As a result, the electrostatic latent image is formed on the circumferential surface of the photosensitive drum 45 in the vicinity of the upper end of the photosensitive drum 45.

Then, as the photosensitive drum 45 rotates in the direction of the arrow R1, the portion of the photosensitive drum 45 where the electrostatic latent image is formed comes in contact with the development roller 43. With this, the toner is adhered to the electrostatic latent image on the circumferential surface of the photosensitive drum 45, so that a toner image is developed on the circumferential surface of the photosensitive drum 45 based on the image data. As the photosensitive drum 45 rotates, the developed toner image reaches the nip position between the transfer roller 34 and the photosensitive drum 45, that is, the transfer position QC (the transfer point QC) in the transfer path W2.

At this time, the image formation unit 30 (FIG. 1) charges, by the high voltage applied to the transfer roller 34, the paper P that is conveyed along the conveyance path W2. Due to potential differences, the toner image is transferred from the circumferential surface of the photosensitive drum 45 to the paper P at the transfer position QC. Further, the image formation unit 30 removes the toner remaining on the circumferential surface of the photosensitive drum 45 that has passed through the transfer position QC, using the cleaning member 48.

In this way, the image formation unit 30 forms the toner image based on the print data and transfers at the transfer position QC the toner image onto the paper P that is conveyed from the front side along the transfer path W2.

A fixation unit 50 (or a fixation device) is disposed on the rear side of the conveying unit 20, that is, on the rear side of the rearmost image formation unit 30C. The fixation unit 50 includes a fixing roller 51, a pressurizing roller 52, a heater 53, and the like. The fixing roller 51 and the pressurizing roller 52 are each rotatably supported at positions above and below the fixing path W3, respectively. The pressurizing roller 52 is biased to the fixing roller 51 by a biasing member.

To perform the printing process, the fixation unit 50 rotates the fixing roller 51 and the pressurizing roller 52 and generates heat using the heater 53 in advance. Thereafter, when the paper P is conveyed along the fixing path W3, the fixation unit 50 holds the paper P between the fixing roller 51 and the pressurizing roller 52, applying heat and pressure to fix the toner onto the paper P, and then discharges the paper P in a rearward and upward diagonal direction.

A duplex printing unit 55 (also referred to as a double-sided printing unit or device) is provided on the rear and lower sides of the fixation unit 50. The duplex printing unit 55 includes a switcher 56 provided on the rear side of the fixation unit 50, and forms paths, such as a circulation path W4 and a temporary evacuation path W5, by means of multiple conveyance guides and multiple pairs of conveyance rollers. Among them, the circulation path W4 is formed to connect the switcher 56 and the conveyance roller pair 17 of the paper feeder 10.

When performing duplex printing, the duplex printing unit 55 switches the switcher 56 under the control of the controller 3, to guide the paper P into the temporary evacuation path W5. Subsequently, after the trailing end of the paper P passes through the switcher 56, the duplex printing unit 55 reverses the conveying direction of the paper P, guides the paper P along the circulation path W4 to return the paper P into the feeding path W1 of the paper feeder 10 near the pair of conveyance rollers 17. As a result, the duplex printing unit 55 can feed the paper P, with its front to back sides reversed, from the feeding path W1 to the transfer path W2, thereby allowing an image to be transferred onto the back side of the paper P. Note that, when the second-side printing is not performed on the paper P, or when image transfer to the second side (back surface) of the paper P is completed, the duplex printing unit 55 causes the paper P to advance upwardly backward.

A discharging unit 60 (or discharging device 60) is provided on the rear side or upper side of the switcher 56. The discharging unit 60 has a structure similar to a part of the paper feeder 10, and forms a discharging path W6, which serves as the path for conveying the paper P, by means of a pair of conveyance guides 61 opposed to each other at a predetermined interval. The discharging unit 60 includes a discharge outlet 62 formed at the end of the discharging path W6. Furthermore, a pair of conveyance rollers 63 and 64, and other components, are sequentially arranged along the discharging path W6 in the discharging unit 60.

The discharging unit 60 rotates the pair of conveyance rollers 63 and 64 under the control of the controller 3 to thereby convey the paper P, received from the fixation unit 50 through the switcher 56, along the discharging path W6 and discharges the paper P from the discharge outlet 62 onto the discharge tray 6 formed on the upper surface of the housing 2.

As described above, the image formation apparatus 1 is configured to form (or print) an image by sequentially conveying the paper P along the conveyance paths W, transferring the toner images formed by the image formation units 30 onto the paper P, and fixing the toner images in the fixation unit 50.

### 2. Configuration of Image drum unit

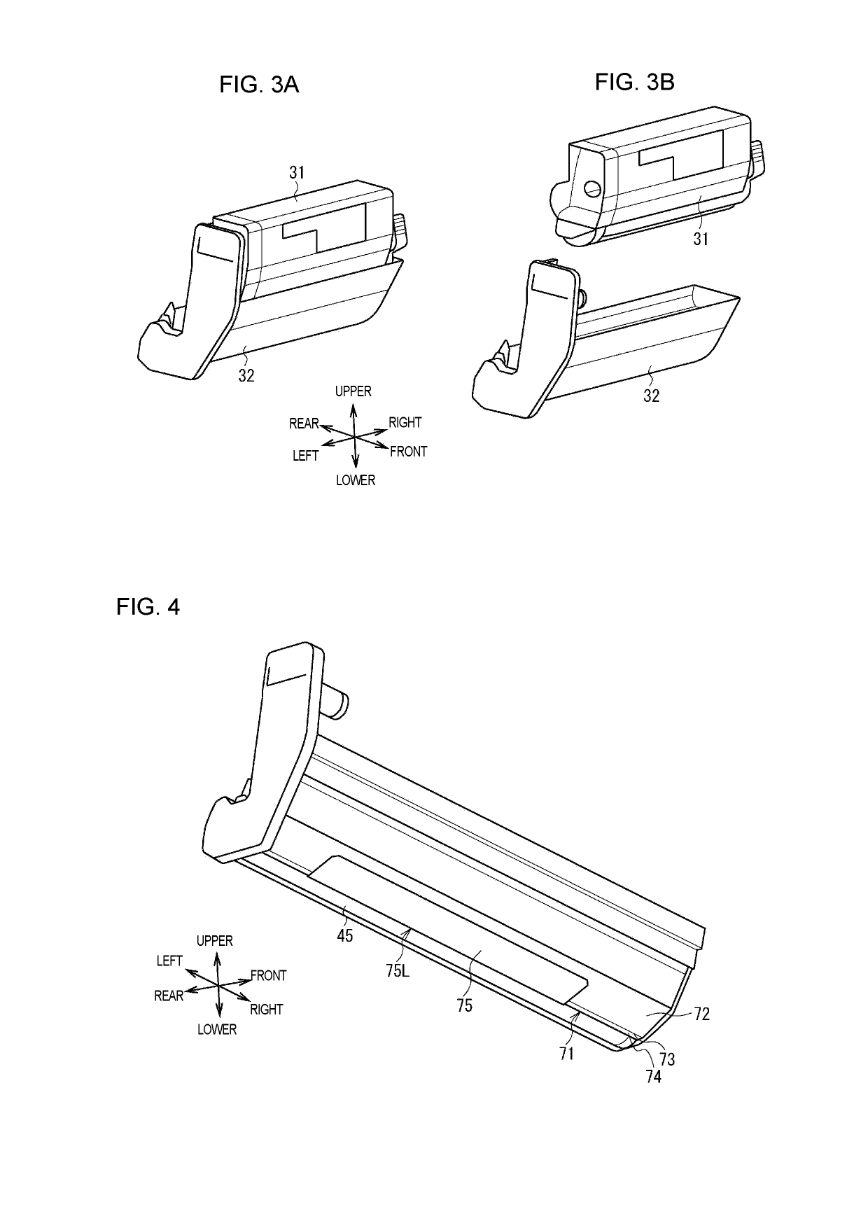

The image formation unit 30 is configured to allow the toner cartridge 31 to be removably attached to the upper side of the image drum unit 32, as illustrated in the schematic perspective views of FIG. 3A and 3B. Note that FIG. 3A illustrates a state in which the toner cartridge 31 is attached to the image drum unit 32, and FIG. 3B illustrates a state in which the toner cartridge 31 is separated from the image drum unit 32.

As illustrated in FIG. 3B, the image drum unit 32 includes a lower portion formed in a horizontally elongated rectangular parallelepiped shape, with a plate portion provided at the upper side of the left end thereof. As illustrated in FIG. 4, which is the perspective view from a direction different from that of FIG. 3B, and in the cross-sectional view of FIG. 2, the image drum unit 32 is configured such that the portion near the lower end of the photosensitive drum 45 is exposed through a drum exposure hole 71 formed in the bottom of the base frame 40.

A first guide surface 72, a connecting guide surface 73, and a second guide surface 74 are formed on the front-lower or lower surface of the base frame 40, in an area located in front of the drum exposure hole 71.

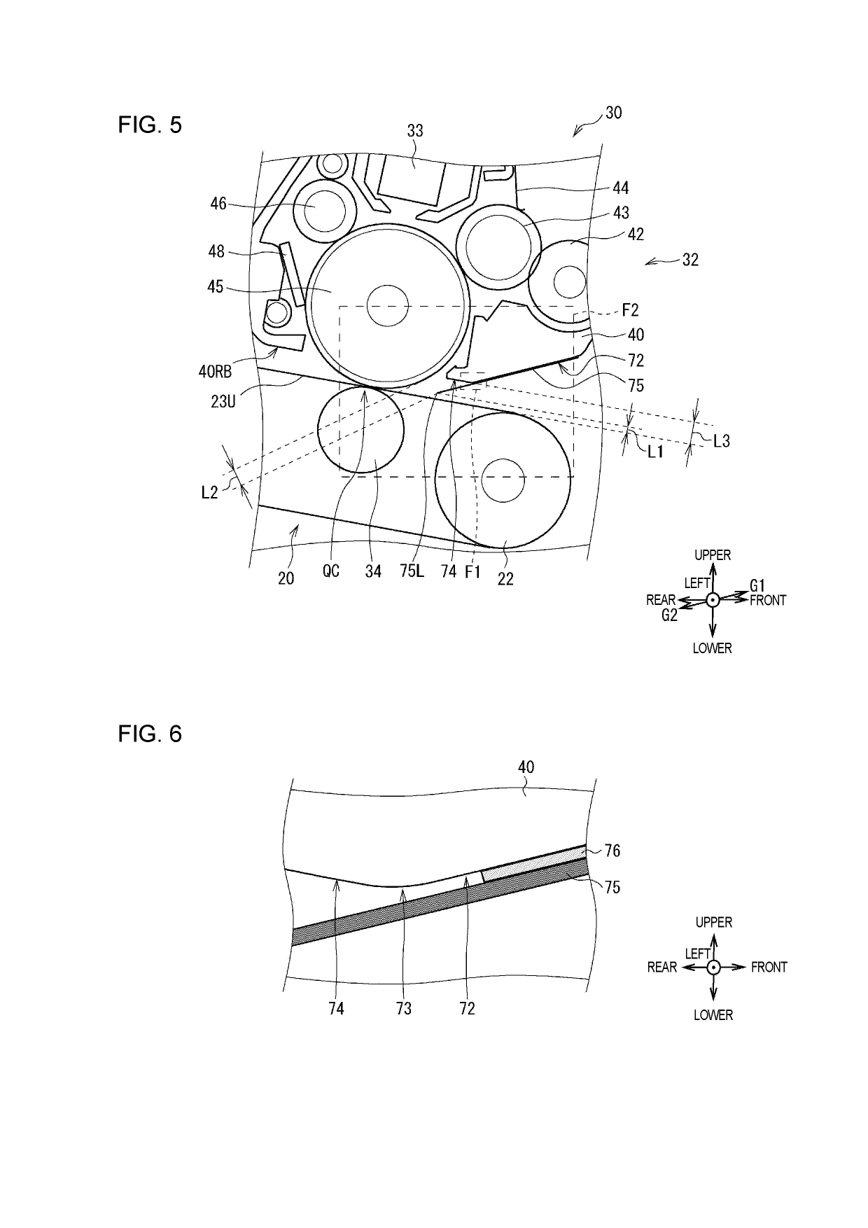

As illustrated in the enlarged side view in FIG. 5, the first guide surface 72 is a flat surface extending from the front upward diagonal side to the rear downward diagonal side, and is inclined at an angle of approximately 23 degrees with respect to the upper conveyance belt part 23U. The second guide surface 74 is located downstream of the first guide surface 72 in the conveyance direction and is a flat surface that is approximately parallel to the upper conveyance belt part 23U. That is, the angle of the second guide surface 74 with respect to the upper conveyance belt part 23U is different from that of the first guide surface 72. For convenience of explanation, hereinafter, among the directions parallel to the first guide surface 72, a front oblique upward direction is referred to as a guide upward direction G1, and a rear oblique downward direction, which is opposite to the guide upward direction G1, is referred to as a guide downward direction G2. The guide upward direction G1 and the guide downward direction G2 collectively referred to as the guide direction G.

As illustrated in FIG. 6, which is the enlarged view of the portion corresponding to the enclosed area F1 in FIG. 5, the connecting guide surface 73 is positioned between the first guide surface 72 and the second guide surface 74, and is formed in a curved shape that smoothly connects the two guide surfaces 72 and 74. That is, the connecting guide surface 73 is curved in an arc shape protruding in a direction approaching the upper conveyance belt part 23U when viewed from the left-right direction, and forms a curved surface continuous with the first guide surface 72 and the second guide surface 74, respectively. From another point of view, when viewed from the left-right direction, the connecting guide surface 73 has no apex angle either within the area of the connecting guide surface 73, or at connection portions between the connecting guide surface 73 and the first guide surface 72 and the second guide surface 74.

In addition to such a configuration, the base frame 40 is provided with a guide film 75. The guide film 75 is formed in an extremely thin, plate-like—i.e., film-like—shape from a resin material with sufficient light-shielding properties, and has a thickness of 0.188 mm. The guide film 75, as illustrated in FIG. 4, is formed in a rectangular shape as a whole. Furthermore, the guide film 75 has higher rigidity than the paper P having the weight (basis weight) of 120 g/m².

As illustrated in FIG. 6, the guide film 75 is affixed to the first guide surface 72 by double-sided adhesive tape 76. Therefore, as illustrated in FIG. 5, the surface of the guide film 75 is parallel to the first guide surface 72 and is inclined to form an angle of approximately 23 degrees with respect to the upper conveyance belt part 23U.

As illustrated in FIG. 4, the guide film 75 has a length in the left-right direction (i.e., the width direction or the main scanning direction) that is slightly shorter than that of the base frame 40. Specifically, the guide film 75 has the length in the left-right direction of approximately 81% of the maximum paper width, which is the width of the paper P having the largest width conveyable by the conveying unit 20.

Furthermore, as illustrated in FIG. 5, the guide film 75 has the length that is longer than that of the first guide surface 72 in the guide direction G. An end portion of the guide film 75 on the guide upward direction G1 side is substantially aligned with the end portion of the first guide surface 72. On the other hand, the guide film 75 has a portion, including an end on the guide downward direction G2 side (hereinafter referred to as a lower end 75L of the guide film or a guide member end), that protrudes further in the guide downward direction G2 than the end of the first guide surface 72.

Here, the shortest distance from the lower end 75L of the guide film to the upper conveyance belt part 23U, which is referred to as a lower end-to-belt distance L1, is greater than the maximum paper thickness, which refers to the thickness of paper P having the greatest printable thickness as specified in the specifications of the image formation apparatus. The lower end-to-belt distance L1 is smaller than a lower end-to-drum distance L2, which is the shortest distance from the guide film lower end 75L to the photosensitive drum 45. It should be noted that the lower end-to-belt distance L1 is smaller than a frame-to-belt distance L3, which is the shortest distance from the second guide surface 74 to the upper conveyance belt part 23U. For convenience of explanation, hereinafter, the lower end-to-belt distance L1 may be referred to as a first distance, and the lower end-to-drum distance L2 may be referred to as a second distance, and the frame-to-belt distance L3 may be referred to as a third distance.

In the image formation apparatus 1, when the photosensitive drum 45 and the conveyance belt 23 of the image drum unit 32 come into contact with each other, the conveyance belt 23 deflects and deforms because the photosensitive drum 45 has a higher hardness than the conveyance belt 23. Therefore, in the actual image formation apparatus 1, it may be extremely difficult to accurately measure the lower end-to-belt distance L1, and the like, with reference to the upper part 23U of the conveyance belt.

Therefore, in an embodiment, as a reference for defining the lower end of the lower end-to-belt distance L1, a virtual straight line extending along the conveyance direction, as viewed from the left-right direction, is used instead of the actual upper conveyance belt part 23U. This virtual straight line corresponds to a line obtained by parallel translation of an imaginary tangent line that contacts both the drive roller 21 and the idle roller 22, by a distance equivalent to the thickness of the conveyance belt 23.

In addition, when measuring the lower-end-to-belt distance L1 or other parameters with reference to the upper conveyance belt portion 23U, measurement methods such as using laser light or CAD application or the like executed on a computer device may be appropriately employed. The following describes an example of a specific process of actually measuring the lower end-to-belt distance L1.

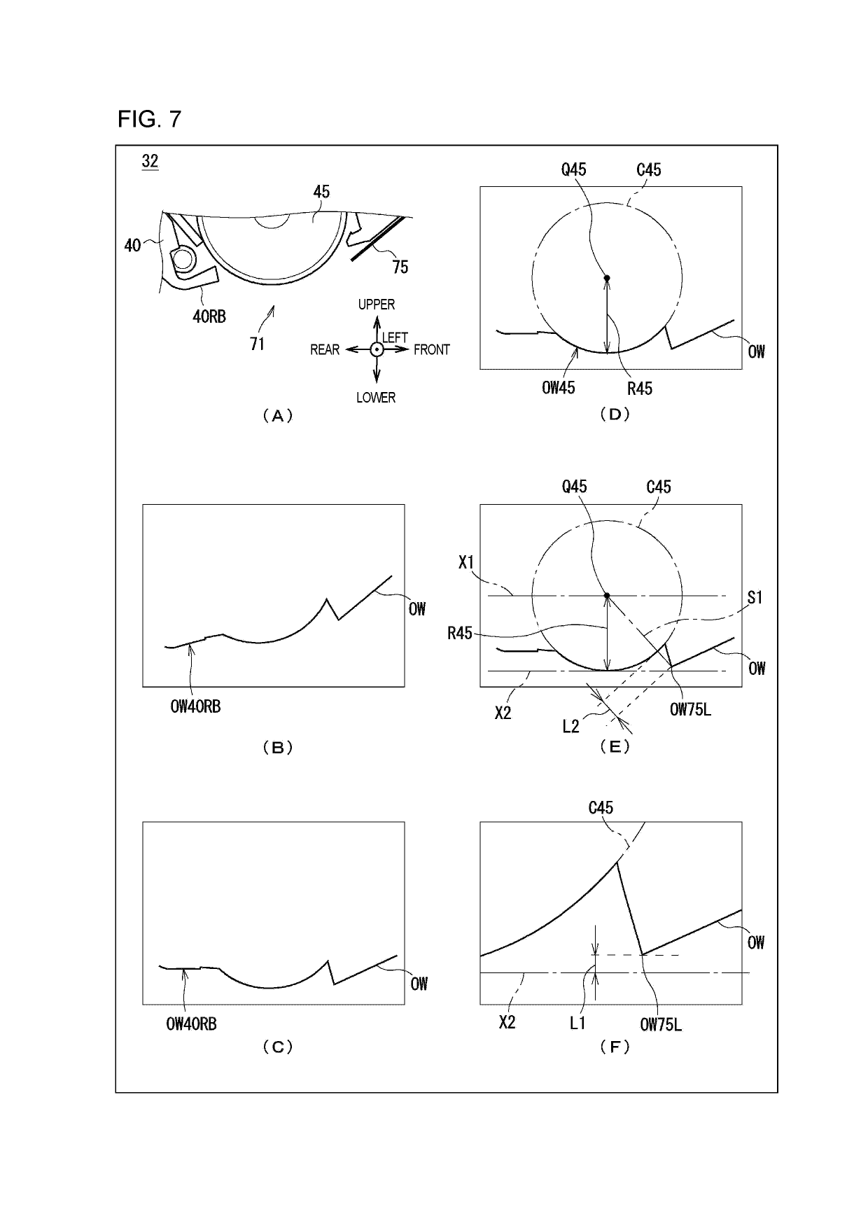

In this measurement process, first, a laser measuring instrument LJ-X8080 (manufactured by KEYENCE CORPORATION) is used to measure the shape of the lower portion of the image drum unit 32 alone (so-called profile), as illustrated in the schematic cross-sectional view in FIG. 7(A). In this case, with respect to the left-right direction, the shape is measured at the central portion of the image drum unit 32 (see FIG. 4), which is the portion where the guide film 75 is provided. As a result, shape data as illustrated in FIG. 7(B) is generated. The shape data accurately represents an external profile (i.e., a contour) of the image drum unit 32 as viewed from the left-right direction, and includes representations of portions of components such as the base frame 40, the photosensitive drum 45, and the guide film 75 in the image drum unit 32.

Next, the CAD (Computer Aided Design) application is executed in a predetermined computer device to acquire the shape data using the data loading function of the CAD application. Hereinafter, in the shape data acquired at that time, the line representing the external profile (i.e., contour) of the image drum unit 32 is referred to as an outline OW (or an outer shape line OW).

Meanwhile, as illustrated in FIG. 7(A), in the image drum unit 32, the base frame 40 includes a flat rear bottom surface 40RB formed on the rear side of the drum exposure hole 71 in the base frame 40. The rear bottom surface 40RB of the base frame is designed to be a flat surface parallel to the upper part 23U of the conveyance belt in a state in which the image drum unit 32 is mounted to the image formation apparatus 1, as illustrated in FIG. 5 and the like.

Therefore, as illustrated in FIG. 7(C), the entire shape data is rotated in the CAD application so that the portion of the outline OW corresponding to the rear bottom surface 40RB of the base frame—referred to as a rear bottom surface outline OW40RB—is aligned with the horizontal direction. Thus, the horizontal direction in the CAD application represents a direction parallel to the conveyance direction in the image formation apparatus 1.

Next, as illustrated in FIG. 7(D), within the CAD application, three points spaced apart from one another are selected on an arc-shaped portion of the outline OW of the photosensitive drum 45—referred to as a photosensitive drum outline OW45. A circle passing through the three points, which is referred to as a drum circle C45, is generated, and the center point of the drum circle, which is referred to as a drum center point Q45, is identified. At this time, a drum circle radius R45, which is the radius of the drum circle C45, is also calculated.

Next, as illustrated in FIG. 7(E), a horizontal straight line X1 passing through the drum center point Q45 is created, and by shifting this line downward by the drum radius R45, the straight line X2 is generated. The straight line X 2 is a straight line that contacts the drum circle C45, that is, a tangent line. The straight line X2 also corresponds to the surface of the upper conveyance belt part 23U (FIG. 5, etc.) in a hypothetical case where the upper conveyance belt part 23U does not bend and remains linear. Therefore, the straight line X 2 can be regarded as a reference when measuring the lower end-to-belt distance L 1 or other distances.

Finally, as illustrated in the enlarged view in FIG. 7(F), the CAD application calculates, as the lower end-to-belt distance L1, the distance in the vertical direction between the straight line X2 and the guide film lower end 75L on the outline OW (referred to as a film lower end outline point OW75L).

Further, as illustrated in FIG. 7(E), in the CAD application, by creating an auxiliary straight line S1 that connects the drum center point Q45 and the film lower end outline point OW75L, the distance along this auxiliary line S1 from the intersection point with the drum circle C45 to the film lower end outline point OW75L can be calculated as the lower end-to-drum distance L2.

Furthermore, with respect to the frame-to-belt distance L3, it is conceivable to measure the shape using a laser measuring device such as the LJ-X8080 in portions near both ends in the left-right direction of the image drum unit 32, i.e., in areas where the guide film 75 is not provided. That is, in the shape data generated in this manner, an outline (not illustrated) having a shape partially different from the outline OW is generated. On this outline, portions corresponding to the photosensitive drum 45 and the second guide surface 74 appear. Therefore, in the CAD application, by generating the straight line X2 in the same manner as described above, the vertical distance between the portion of the outline corresponding to the second guide surface 74 and the straight line X2 can be calculated as the frame-to-belt distance L3.

### 3. Printing processes

Next, a part of the printing process performed by the image formation apparatus 1 that mainly relates to the conveyance of the paper P and the transfer of the toner image is described. Here, it is assumed that the image formation apparatus 1 performs two-sided printing to sequentially print on both sides of the paper P based on a print job supplied from an external device (not illustrated), in which printing on the second side (back surface) of the paper P is started after the printing on the first side (front surface) of the paper P is completed.

At this time, due to various factors in the printing process—such as the application of heat by the fixation unit 50 during the printing on the first side and the conveyance of the paper P through curved sections of the conveyance path W—the paper P may become curved, bending around an imaginary axis extending in the width direction. Hereinafter, it is assumed that the paper P is curved with the second surface side facing inward.

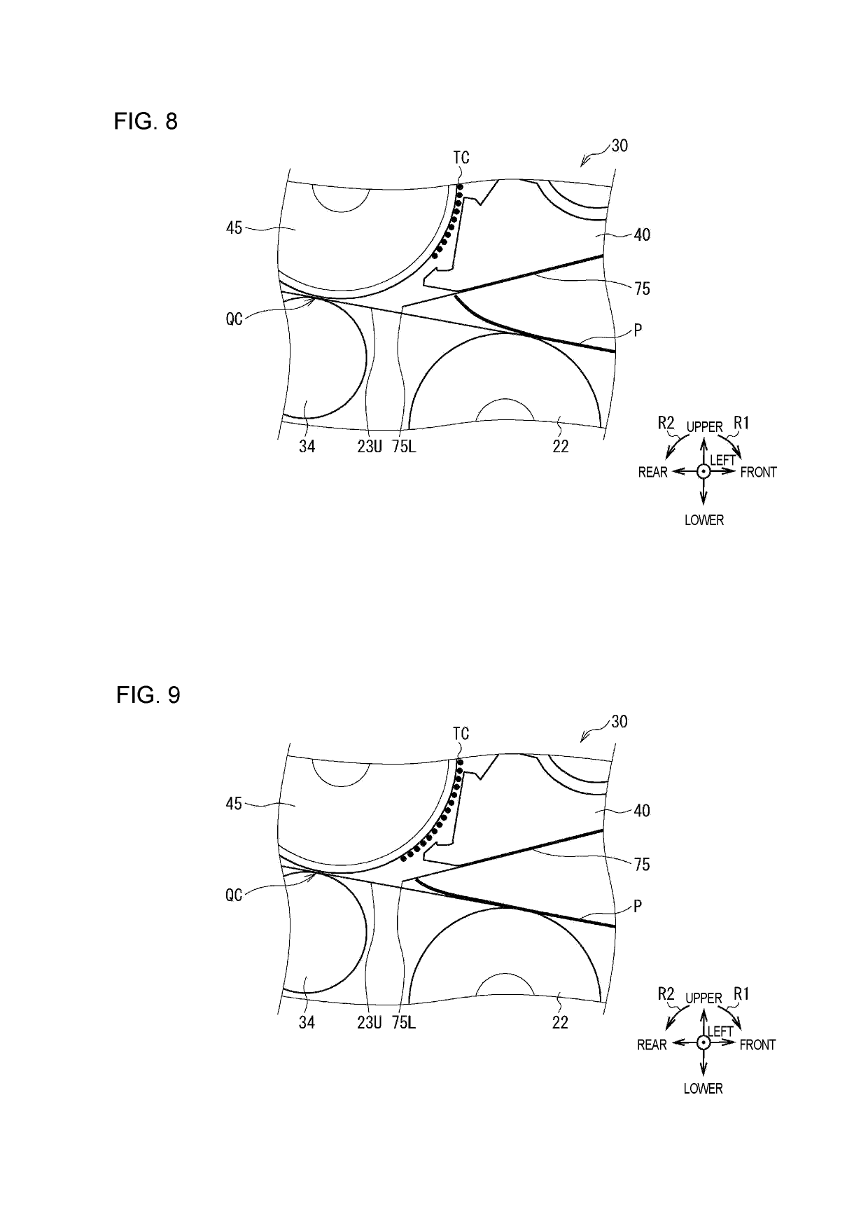

FIGS. 8, 9, 10 and 11, are all schematic diagrams illustrating an enlarged view of the portion corresponding to the enclosed area F2 in FIG. 5. FIGS. 8, 9, 10 and 11, sequentially illustrate the process in which the paper P is conveyed toward the transfer position QC of the image formation unit 30K, which is located upstreammost in the conveyance direction, by the pair of conveyance rollers 17 (see FIG. 1), the conveyance belt 23, and other components.

Of these, FIG. 8 illustrates a state in which the leading end portion of the paper P is positioned in proximity to the front lower side of the base frame 40 in the image drum unit 32 of the image formation unit 30. If the paper P is conveyed in contact with the upper part 23U of the conveyance belt without being curved, the paper P will proceed in the conveyance direction along the upper conveyance belt part 23U without contacting the guide film 75, passing through the space between the lower end 75L of the guide film and the upper conveyance belt part 23U.

However, as described above, in FIG. 8, the paper P is curved and exhibits warping due to the printing process on the first surface of the paper or other factors. Accordingly, the leading end portion of the paper P is significantly displaced away from the upper conveyance belt part 23U and comes into contact with the guide film 75. At this time, in the image formation unit 30, a toner image TC, which is to be printed on the second side of the paper P, is formed on the surface of the photosensitive drum 45, and as the photosensitive drum 45 rotates, the toner image TC approaches the transfer position QC.

The next FIG. 9 illustrates a state in which, from the condition illustrated in FIG. 8, the paper P advances in the conveyance direction (i.e., the rearward and upward diagonal direction along the upper conveyance belt part 23U), as the photosensitive drum 45 rotates in the direction of arrow R1.

Meanwhile, in the image forming apparatus 1, prior verification reveals that the paper P becomes curved at the end of the printing process not in all cases, but predominantly when the basis weight of the paper P falls within a certain specified range. As a result of detailed verification, it is found that the upper limit of the wight (basis weight) at which such a warping is likely to occur is approximately 120 g/m². Therefore, as described above, the guide film 75 having higher rigidity than that of the paper with the basis weight of 120 g/m² is selected.

That is, in the image formation apparatus 1, even if the paper P is warped due to the printing process on the first side or the like, the rigidity of the paper P is lower than that of the guide film 75 since the paper has the basis weight of 120 g/m² or less. Thus, in the image formation apparatus 1, the guide film 75 is hardly bent by the paper P, and the leading end portion of the paper P is slid along the guide film 75.

The paper P is guided by the guide film 75 such that the leading edge portion of the paper P, while being in contact with the guide film 75, slides in a rearward and downward diagonal direction and is gradually brought closer to the upper conveyance belt part 23U. Since the guide film 75 is more rigid than the paper P, it is possible to guide the leading end portion of the paper P while substantially maintaining the shape of the guide film.

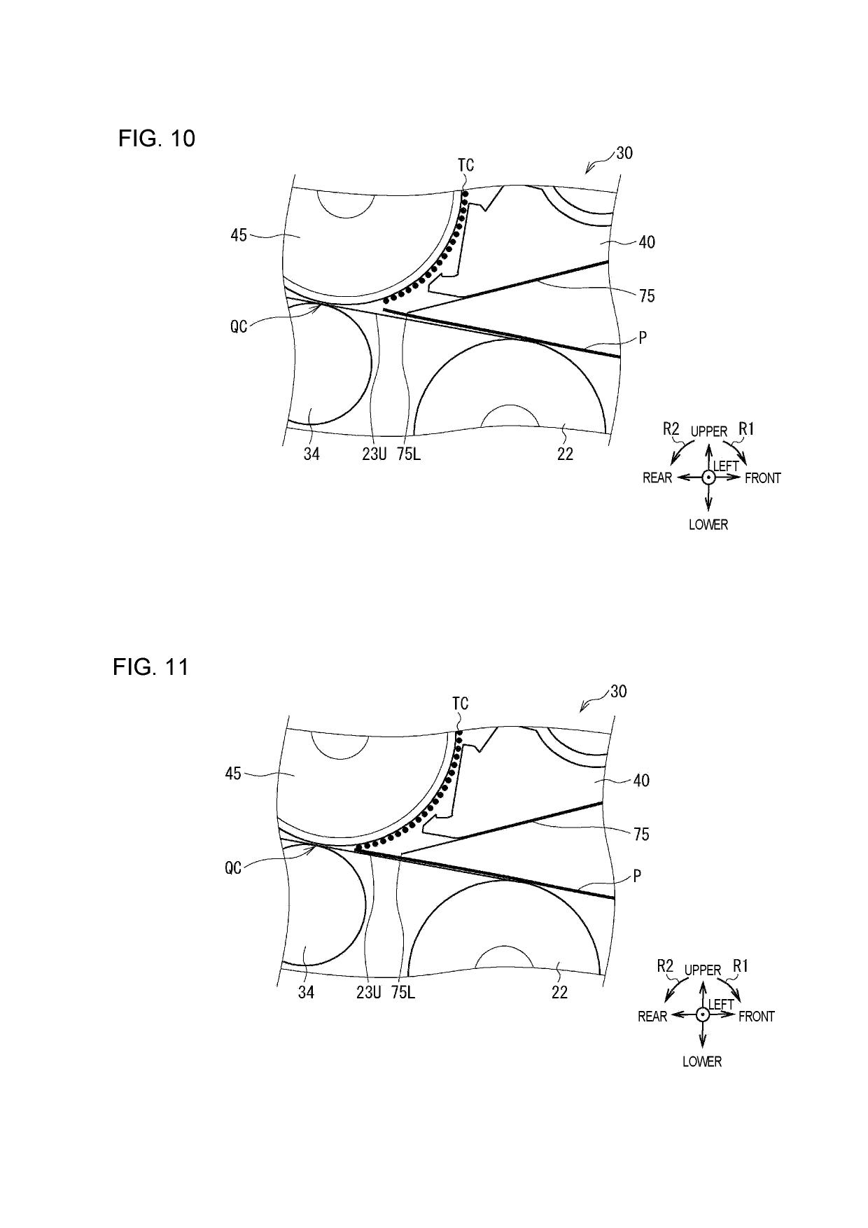

Next, FIG. 10 illustrates a state in which the paper P advances further in the conveyance direction and the photosensitive drum 45 rotates further in the direction of arrow R1, from the state of FIG. 9. In this state, the leading end portion of the paper P is located further downstream in the conveyance direction than the lower end 75L of the guide film 75. In addition, the lower end 75L of the guide film contacts the paper P at a position slightly behind the leading end of the paper P, thereby bringing a wide area of the paper P, including the leading edge portion, into proximity with or in contact with the upper conveyance belt part 23U. That is, the guide film 75 can prevent the leading end portion of the paper P from abutting on the circumferential surface of the photosensitive drum 45.

Next, FIG. 11 illustrates a state in which the paper P advances further in the conveyance direction and the photosensitive drum 45 rotates further in the direction of arrow R1, from the state of FIG. 10. In this state, the paper P reaches a position where the leading end portion of the paper P is close to the transfer position QC and is in contact with the upstream end portion of the toner image TC formed on the circumferential surface of the photosensitive drum 45. Furthermore, the paper P is scarcely in contact with the lower end 75L of the guide film, thereby suppressing the generation of sliding resistance and allowing smooth conveyance.

Thereafter, as the paper P passes through the transfer position QC from the leading end to trailing end of the paper P, the toner image TC is transferred from the circumferential surface of the photosensitive drum 45 to the paper P at the transfer position QC. Thereafter, the toner images TC formed by the downstream image formation units 30 are sequentially transferred to the paper P in a superimposed manner, and the superimposed toner images TC are fixed to the paper P by the fixation unit 50, thereby completing the printing process in the image formation apparatus 1.

### 4. Effects and the like

In the configuration described above, the image formation apparatus 1 according to an embodiment is configured such that the guide film 75 is provided on the base frame 40 of the image drum unit 32 in the image formation unit 30 (e.g., FIGS. 4 and 5). The guide film 75 is mounted such that a majority portion of the guide film 75 overlaps the first guide surface 72 of the base frame 40, with the lower end 75L of the guide film and a vicinity thereof protruding beyond the end of the first guide surface 72 in the guide downward direction G2.

Therefore, according to the image formation apparatus 1, as the paper P is conveyed to the transfer position QC of the image formation unit 30 along the conveyance path W, the guide film 75 can bring the leading end portion of the paper P closer to the upper conveyance belt part 23U while being in contact with the leading end portion. Furthermore, according to the image formation apparatus 1, even after the leading end portion of the paper P is conveyed beyond the lower end 75L of the guide film toward the transfer position QC, the lower end 75L of the guide film can bring the paper P closer to, or into contact with, the upper conveyance belt part 23U.

Thus, the image formation apparatus 1 can stably convey the paper P along the conveyance belt 23 so that the toner images of respective colors can be transferred to appropriate positions onto the paper P by the image formation units 30. Furthermore, the image formation apparatus 1 can prevent the leading end portion of the paper P from unnecessarily abutting the circumferential surface of the photosensitive drum 45, thereby preventing the toner image TC on the circumferential surface of the photosensitive drum 45 from being scraped off. As a result, the image formation apparatus 1 can print a high-quality image on the paper P.

Meanwhile, since the photosensitive drum 45 is a consumable item, the image formation apparatus 1 (FIG. 1) is configured such that the image drum unit 32 of the image formation unit 30 can be easily attached to and detached from the housing 2. Therefore, in the image formation apparatus 1, it may be preferable to form a relatively large gap between the mounted image drum unit 32 and the surrounding parts, etc., which can absorb manufacturing errors, etc.

For example, the base frame 40 of the image drum unit 32 is made of a relatively rigid material, as the base frame 40 may need to rotatably support components such as the photosensitive drum 45 and various rollers while maintaining the positional relationships therebetween. On the other hand, the conveyance belt 23, which comes into contact with the photosensitive drum 45, circulates around the drive roller 21 and the idle roller 22 within the conveyance unit 20. Therefore, the conveyance belt 23 has a structure with sufficient flexibility and may be relatively easily damaged when coming into contact with a high-strength component.

Therefore, as illustrated in FIG. 5 and other figures, the image drum unit 32 is configured to have a relatively large gap corresponding to the frame-to-belt distance L3 between the lower surface of the base frame 40 and the upper part 23U of the conveyance belt, thereby preventing damage caused by contact with the upper conveyance belt part 23U. Furthermore, in the image drum unit 32, the lower portion of the base frame 40 is formed with the first guide surface 72, the connecting guide surface 73, the second guide surface 74, and the like, located on the front side (i.e., upstream side) of the drum exposure hole 71. Accordingly, if the paper is curved and the leading edge portion of the paper is lifted away from the upper conveyance belt part 23U, the image drum unit 32 can guide the paper P, conveyed by the conveyance unit 20, closer to the upper conveyance belt part 23U.

However, as described above, in the image drum unit 32, the portion represented by the frame-to-belt distance L3—i.e., the gap between the end of the first guide surface 72 on the guiding downward side G2 and the upper conveyance belt part 23U, as well as the gap between the second guide surface 74 and the upper conveyance belt part 23U—is relatively large.

Therefore, in the image drum unit 32, the first guide surface 72 alone may not be sufficient to guide the leading end portion of the paper P to the vicinity of the upper conveyance belt part 23U, potentially resulting in unstable conveyance by the conveyance belt 23. In this case, in the image drum unit 32, there may be a risk that the leading end portion of the paper P may come into contact with the circumferential surface of the photosensitive drum 45 through the gap defined by the frame-to-belt distance L3, thereby scraping off the toner image TC from the photosensitive drum 45.

In view of this, in the image drum unit 32 according to an embodiment, the guide film 75, which is made of a flexible material in the form of a thin film, is attached to the first guide surface 72, with the lower end 75L of the guide film 75 positioned closer to the upper conveyance belt part 23U than the end of the first guide surface 72 on the guide downward side G2 (see FIG. 5, etc.).

Thus, according to the image formation apparatus 1, even if the paper P is curved and the leading end portion of the paper P is raised from the upper conveyance belt part 23U, the guide film 75 can guide the leading end portion of the paper P to a position in the vicinity of the upper conveyance belt part 23U, that is, to a position closer to the upper conveyance belt part 23U than the end of the first guide surface 72 on the guide downward side G2. Thus, the image formation apparatus 1 can stably convey the paper P as a state along the conveyance belt 23, and can prevent the leading end portion of the paper P from scraping off the toner image TC from the circumferential surface of the photosensitive drum 45.

Additionally, the guide film 75 is made of a flexible material in the form of a thin film. Therefore, according to the image formation apparatus 1, even if the guide film 75 comes into contact with the conveyance belt 23, the guide film 75 can be appropriately deformed to prevent damage to the conveyance belt 23. Furthermore, according to the image formation apparatus 1, the connecting guide surface 73 is curved, so that there may be no risk of the guide film 75 being damaged by contact with the base frame 40.

Viewed from another perspective, according to the image forming apparatus 1, the image drum unit 32 can be easily configured by simply attaching the guide film 75 to the first guide surface 72 of the base frame 40 of a comparative image drum unit that does not include the guide film 75. Accordingly, it may not be necessary to make design changes to the base frame 40.

Furthermore, according to the image formation apparatus 1, the image drum unit 32 is configured such that the guide film 75 is made of a resin material having light-shielding properties and is arranged to cover a portion of the photosensitive drum 45 exposed through the drum exposure hole 71 of the base frame 40. Therefore, the image drum unit 32 can reduce the exposure of the photosensitive drum 45 when the image drum unit 32 is removed from the image formation apparatus 1.

According to the above configuration, the image formation apparatus 1 is provided with the guide film 75 on the first guide surface 72 of the base frame 40 in the image drum unit 32 of the image formation unit 30, and the lower end 75L of the guide film protrudes beyond the first guide surface 72 toward the upper conveyance belt part 23U. Therefore, according to the image formation apparatus 1, even if the conveyed paper P is curved and the leading end portion of the paper P is lifted from the upper conveyance belt part 23U, the guide film 75 causes the leading end portion of the paper P to slide along the guide film 75 to guide the leading end portion toward the upper conveyance belt part 23U. In addition, the lower end 75L of the guide film further bring the paper P into proximity with, or into contact with, the upper conveyance belt part 23U. Thus, the image formation apparatus 1 is capable of preventing the leading end portion of the paper P from coming into contact with the circumferential surface of the photosensitive drum 45 and scraping off the toner image TC, thereby enabling high-quality image printing on the paper P.

### 5. Modifications

In an embodiment described above, a case has been described in which the guide film 75 is attached to the image drum unit 32 in each of the four image formation units 30 in the image formation apparatus 1. However, the invention is not limited thereto. For example, the guide film 75 may be attached to only one or more of the image drum units 32 of the image formation units 30, for example, only to the image drum unit 32 of the image formation unit 30K, which is located at the most upstream position in the conveyance direction.

In an embodiment described above, a case has been described in which the lower end-to-belt distance L1, which is the shortest distance from the lower end 75L of the guide film to the upper part 23U of the conveyance belt in the image drum unit 32 (FIG. 5), is greater than the maximum paper thickness. However, the invention is not limited thereto. For example, the lower end-to-belt distance L1 may be set based on the lengths of various other parts, such as by making the lower end-to-belt distance L1 one-fourth or more of the frame-to-belt distance L3, which is the distance between the second guide surface 74 and the upper conveyance belt part 23U.

Furthermore, in an embodiment described above, a case has been described in which the lower end-to-belt distance L1 in the image drum unit 32 (FIG. 5) is smaller than the lower end-to-drum distance L2, which is the shortest distance from the lower end 75L of the guide film to the photosensitive drum 45. However, the invention is not limited thereto. For example, the lower end-to-belt distance L1 may be equal to or more than the lower end-to-drum distance L2.

Furthermore, in an embodiment described above, a case has been described in which the length of the guide film 75 in the image drum unit 32 (FIG. 4), in the main scanning direction (the left-right direction), is approximately 81% of the maximum paper width. However, the invention is not limited thereto. For example, the length of the guide film 75 may be set to various values such as 90%, 105%, or other percentages of the maximum paper width. In this case, based the experimental results or the like, it is found that if the length of the guide film 75 is approximately 80% or more of the maximum paper width, it is possible to effectively prevent the paper P from coming into contact with the circumferential surface of the photosensitive drum 45 and scraping off the toner image TC.

Furthermore, in an embodiment described above, a case has been described in which the rigidity of the guide film 75 is higher than the rigidity of the paper P having the weighing (basis weight) of 120 g/m². However, the invention is not limited thereto. For example, the rigidity of the guide film 75 may be set higher than that of paper P with various basis weights, such as 100 g/m², 150 g/m², or other values. In these cases, the rigidity of the guide film 75 may be determined based on the upper limit of the basis weight at which curvature may occur in the paper P after performing printing process in the image forming apparatus 1.

Furthermore, in an embodiment described above, a case has been described in which the base frame 40 of the image drum unit 32 is formed with the second guide surface 74, which is provided on the guide downward side G2 of the first guide surface 72 and is substantially parallel to the upper conveyance belt part 23U, and the connecting guide surface 73 between the first guide surface 72 and the second guide surface 74 (see FIG. 6, etc.). However, the invention is not limited thereto. For example, instead of the second guide surface 74, various shapes may be used, such as a curved guide surface that protrudes downward.

Furthermore, in an embodiment described above, a case has been described in which the first guide surface 72 of the base frame 40 in the image drum unit 32 is in the flat shape (FIGS. 4 and 5, etc.). However, the invention is not limited thereto. For example, the first guide surface 72 may be formed as a curved surface, or may be composed of multiple flat surfaces having different angles connected to form a bent surface having a polygonal profile when viewed from the left-right direction. Various other shapes may also be employed. In this case, it may be sufficient if the guide film 75 is attached in accordance with the shape of the first guide surface 72.

Furthermore, in an embodiment described above, a case has been described in which the first guide surface 72 of the base frame 40 and the upper conveyance belt part 23U form the angle of approximately 23 degrees therebetween. However, the invention is not limited thereto. For example, various angles may be employed, such as approximately 30 degrees, 15 degrees, or other angles. In short, it may be sufficient that the leading edge portion of the paper P is slid and guided to the vicinity of the upper conveyance belt part 23U.

Furthermore, in an embodiment described above, a case has been described in which the guide film 75 is attached to the first guide surface 72 of the base frame 40 in the image drum unit 32 by the double-sided adhesive tape 76. However, the invention is not limited thereto. For example, the guide film 75 may be attached using a well-known adhesive, or mounting screws, or the like. Alternatively, for example, corresponding engagement portions may be formed on the guide film 75 and the base frame 40, respectively, to engage them with each other.

Furthermore, in a first embodiment described above, a case has been described where the four image formation units 30 are provided in the image formation apparatus 1. However, the invention is not limited thereto. For example, the image formation apparatus 1 may include either three or fewer, or five or more, image formation units 30.

Furthermore, in one or more embodiments described above, a case has been described in which the image formation apparatus 1 is configured as a single-function printer. However, the invention is not limited thereto. For example, an image formation apparatus may be configured as a multi-function peripheral (MFP) having functions such as a copier, a facsimile machine, or other devices.

Furthermore, the invention is not limited to one or more embodiments and modifications described above. That is, the application range of the invention covers embodiments obtained by arbitrarily combining some of or all of the embodiments described above and the other embodiments described above as well as embodiments obtained by extracting some of those embodiments.

Furthermore, in an embodiment described above, a case has been described in which the image formation apparatus 1 serving as an image formation apparatus is configured including the tray 5 and the paper feeder 10 serving as a media feeder, the conveyance belt 23, the image drum unit 32 and the transfer roller 34 serving as an image transfer part, and the guide film 75 serving as a guide member. However, the invention is not limited to this. For example, an image formation apparatus may be configured including a medium feeder, a conveyance belt, an image transfer part, and a guide member at least one of which may have a configuration different from the above-described configurations.

The disclosure can be used, for example, in an electrophotographic printer.

1. An image formation apparatus comprising:
a medium feeder configured to supply a medium;
a conveyance belt configured to convey the medium supplied from the medium feeder toward a fixation device along a conveyance direction;
an image transfer part configured to transfer an image formed on an image carrier at a transfer position to the medium being conveyed by the conveyance belt; and
a flexible guide member that is provided upstream in the conveyance direction of the transfer position in the image transfer part, and is arranged to approach the conveyance belt as the guide member extends downstream in the conveyance direction, and
a shortest distance from a guide member end, which is an end portion of the guide member located on a side close to the conveyance belt, to the conveyance belt is greater than a maximum medium thickness specified in apparatus specifications of the image formation apparatus.

2. The image formation apparatus according to claim 1, wherein
a first distance, which is the shortest distance from the guide member end to the conveyance belt, is smaller than a second distance, which is a shortest distance from the guide member end to the image carrier.

3. The image formation apparatus according to claim 1, wherein
the image transfer part includes a support member that holds the image carrier, the support member includes a first guide surface that approaches the conveyance belt as the first guide surface extends downstream in the conveyance direction, and
the guide member is formed of a flexible member and attached to the first guide surface such that a portion of the guide member protrudes further than the first guide surface toward the conveyance belt.

4. The image formation apparatus according to claim 3, wherein
the image transfer part includes, at the support member: a second guide surface that is provided downstream of the first guide surface in the conveyance direction and has an angle relative to the conveyance belt different from that of the first guide surface; and a connecting guide surface formed as a curved surface connecting the first guide surface and the second guide surface.

5. The image formation apparatus according to claim 1, wherein
the image transfer part comprises a plurality of image transfer parts arranged along the conveyance direction, and
the guide member is provided in one of the plurality of image transfer parts that is disposed on the most upstream side in the conveyance direction.

6. The image formation apparatus according to claim 1, wherein
a rigidity of the guide member is higher than that of the medium that may become curved after printing process in the image formation apparatus.

7. The image formation apparatus according to claim 6, wherein
the rigidity of the guide member is higher than that of the medium with a basis weight of 120 g/m².

8. The image formation apparatus according to claim 1, wherein
the guide member has a length, in a width direction orthogonal to the conveyance direction of the medium conveyed by the image transfer part, that is 80% or more of a maximum medium width, which is a width of the medium having the largest width suppliable from the medium feeder.

9. An image formation apparatus comprising:
a medium feeder configured to supply a medium,
a conveyance belt configured to convey the medium supplied from the medium feeder toward a fixation device along a conveyance direction;
an image transfer part configured to transfer an image formed on an image carrier at a transfer position to the medium being conveyed by the conveyance belt; and
a flexible guide member that is provided upstream of the conveyance direction from the transfer position in the image transfer part, and is arranged to approach the conveyance belt as the guide member extends downstream in the conveyance direction, wherein
a first distance, defined as a shortest distance from a guide member end, which is an end portion of the guide member located on a side close to the conveyance belt, to the conveyance belt is smaller than a second distance, defined as a shortest distance from the guide member end to the image carrier.
